(19) United States
(12) Patent Application Publication
(10) Pub. No.: US 2022/0069511 A1
(43) Pub. Date: Mar. 3, 2022

(54) CONNECTOR

(71) Applicant: Yazaki Corporation, Tokyo (JP)

(72) Inventors: Satoki MASUDA, Shizuoka (JP); Hikaru OI, Shizuoka (JP)

(73) Assignee: Yazaki Corporation, Tokyo (JP)

(21) Appl. No.: 17/463,839

(22) Filed: Sep. 1, 2021

(30) Foreign Application Priority Data
Sep. 2, 2020 (JP) 2020-147201

(51) Int. Cl. H01R 13/52

(52) U.S. Cl. CPC H01R 13/5202

(57) ABSTRACT

A connector includes: a terminal fitting; a housing accommodating the terminal fitting therein and including a fitting portion to be inserted and fitted into a mating fitting portion along a connector insertion direction; a water stop member including an annular water stop main body whose inner circumferential surface is coaxially in close contact with an outer circumferential wall surface of the fitting portion, the water stop member being elastically deformable so as to fill an annular gap between the fitting portion and the mating fitting portion by the water stop main body at a fitting completion position of the fitting portion and the mating fitting portion; and a rotation stop structure provided at a position between the housing and the water stop member to restrict relative rotation in a circumferential direction of the water stop member relative to the fitting portion.

### CROSS-REFERENCE TO RELATED APPLICATION(S)

The present application claims priority to and incorporates by reference the entire contents of Japanese Patent Application No. 2020-147201 filed in Japan on Sep. 2, 2020.

### BACKGROUND OF THE INVENTION

### 1. Field of the Invention

The present invention relates to a connector.

### 2. Description of the Related Art

As a conventional connector, there is known a connector including a housing that accommodates a terminal fitting therein and is provided with a fitting portion to be inserted and fitted into a mating fitting portion, and a water stop member (seal member such as a gasket) that fills an annular gap between the fitting portion and the mating fitting portion at a fitting completion position with its inner circumferential surface coaxially in close contact with an outer circumferential wall surface of the fitting portion. For example, this type of connector is disclosed in Japanese Patent Application Laid-open No. 2004-172009. This connector includes a rotation stop structure for the water stop member relative to the fitting portion. The rotation stop structure is composed of a protrusion-shaped locking portion provided in the water stop member, and a cutout-shaped restriction portion provided on the outer circumferential surface side of the housing so as to accommodate the locking portion. The rotation stop structure restricts relative rotation in a circumferential direction of the water stop member relative to the fitting portion by circumferentially locking the locking portion in the restriction portion.

Unfortunately, in the conventional rotation stop structure, the locking portion may be turned over because of its structure. Thus, if the turned-over locking portion escapes from the restriction portion in the conventional rotation stop structure, the restriction portion cannot circumferentially restrict the locking portion. Even if the turned-over locking portion does not escape from the restriction portion, a contact area in the circumferential direction between the restriction portion and the locking portion is reduced. Thus, the rotation stop structure may not be able to stop the rotation of the water stop member relative to the fitting portion.

### SUMMARY OF THE INVENTION

An object of the present invention is to provide a connector capable of maintaining a state in which rotation of a water stop member relative to a fitting portion can be stopped.

To achieve the above objection, a connector according to one aspect of the invention includes a terminal fitting; a housing accommodating the terminal fitting therein and including a fitting portion to be inserted and fitted into a mating fitting portion along a connector insertion direction; a water stop member including an annular water stop main body, an inner circumferential surface of which is coaxially in close contact with an outer circumferential wall surface of the fitting portion, the water stop member being elastically deformable so as to fill an annular gap between the fitting portion and the mating fitting portion by the water stop main body at a fitting completion position of the fitting portion and the mating fitting portion; and a rotation stop structure provided at a position between the housing and the water stop member to restrict relative rotation m a circumferential direction of the water stop member relative to the fitting portion, wherein the rotation stop structure includes a portion to be accommodated protruding from an annular end surface in an axial direction of the water stop main body, and an accommodating portion provided in the housing to maintain the water stop member at an attachment completion position to the fitting portion by inserting from an opening and accommodating the portion to be accommodated.

According to another aspect of the present invention, in the connector, it is preferable that the portion to be accommodated is formed in a piece body shape having a locked end at a first end and a locked end at a second end in the circumferential direction, and a first locked wall surface on the inner circumferential surface side and a second locked wall surface on an outer circumferential surface side of the water stop main body, the first locked wall surface and the second locked wall surface extending along the circumferential direction and the axial direction, and the accommodating portion has a locking wall at a first end in the circumferential direction capable of locking the locked end at the first end, a locking wall at a second end in the circumferential direction capable of locking the locked end at the second end, a first locking wall surface capable of locking the first locked wall surface, and a second locking wall surface capable of locking the second locked wall surface.

According to still another aspect of the present invention, in the connector, it is preferable that the locked ends and the locking walls paired at two positions have tapered surfaces to be brought into abutment against each other in each pair to lock movement of the locked ends toward the second locked wall surface when the tapered surfaces are in a circumferentially locked state.

According to still another aspect of the present invention, in the connector, it is preferable that the housing includes a housing body provided with the fitting portion, and a front holder into which a distal end of the fitting portion on the connector insertion direction side, protruding from the water stop main body, is coaxially inserted, the accommodating portion is provided in at least one of the housing body and the front holder, when the accommodating portion is provided in the housing body, the portion to be accommodated protrudes from one of the annular end surfaces of the water stop main body in a direction opposite to the connector insertion direction, and when the accommodating portion is provided in the front holder, the portion to be accommodated protrudes from the other of the annular end surfaces of the water stop main body in the connector insertion direction.

According to still another aspect of the present invention, in the connector, it is preferable that the rotation stop structure includes a combination of the portion to be accommodated protruding from one of the annular end surfaces of the water stop main body and the accommodating portion, and further includes a portion to be locked protruding from the other of the annular end surfaces of the water stop main body, and a locking portion provided in the housing and capable of locking the portion to be locked in the circumferential direction while maintaining the water stop member at the attachment completion position, the portion to be locked has a locked end at a first end and a locked end at a second end in the circumferential direction, and an outer wall surface on the outer circumferential surface side of the water stop main body extending along the circumferential direction and the axial direction, the locking portion has a locking wall at a first end in the circumferential direction capable of locking the locked end at the first end of the portion to be locked, a locking wall at a second end in the circumferential direction capable of locking the locked end at the second end of the portion to be locked, and an exposure opening from which the outer wall surface of the portion to be locked is exposed to an outside between the locking walls, the locked ends and the locking walls paired at at least one position in the portion to be locked and the locking portion have tapered surfaces to be brought into abutment against each other to lock movement of the locked ends toward the outer wall surface, the housing includes a housing body provided with the fitting portion, and a front holder into which a distal end of the fitting portion on the connector insertion direction side, protruding from the water stop main body, is coaxially inserted, the combination or the portion to be accommodated and the accommodating portion is provided at one of a position between the housing body and the water stop member and a position between the front holder and the water stop member, and a combination of the portion to be locked and the locking portion is provided at the other of the position between the housing body and the water stop member and the position between the front holder and the water stop member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FPIG. 1 is a perspective view illustrating a connector of an embodiment before being mounted on a mating apparatus;

FIG. 2 is a plan view illustrating the connector of the embodiment (excluding a shield shell);

FIG. 3 is a cross-sectional view taken along a line X1-X1 in PIG. 2;

FIG. 3 is a cross-sectional view taken along a line X2-X2 in FIG. 2;

FIG. 5 is an exploded perspective view illustrating the connector of the embodiment;

FIG. 6 is a plan view of a housing body as viewed from a fitting portion side;

FIG. 7 is a perspective view illustrating a water stop member;

FIG. 8 is a perspective view illustrating a front holder;

FIG. 9 is an enlarged view of a portion A in FIG. 3;

FIG. 10 is an enlarged view of a portion B in FIG. 4;

FIG. 11 is an enlarged view of a portion C in FIG. 4; and

FIG. 12 is an enlarged view of a portion D in FIG. 4.

### DETAILED DESCRIPTION OF THE PREFERRED EMBODIMENTS

Hereinafter, an embodiment of a connector according to the present invention will be described in detail based on the drawings. It should be noted that the embodiment is not intended to limit the present invention.

### Embodiment

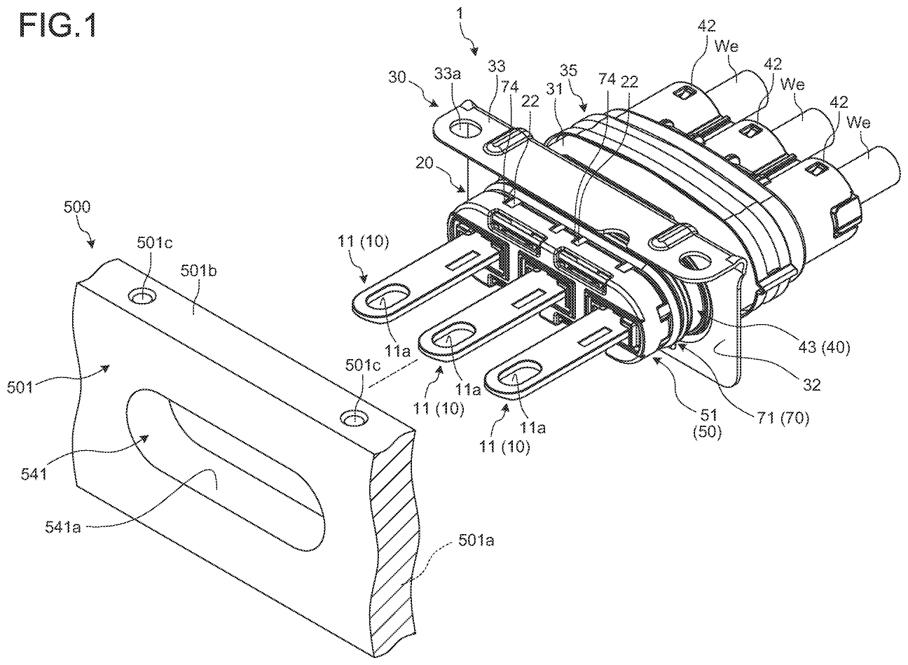

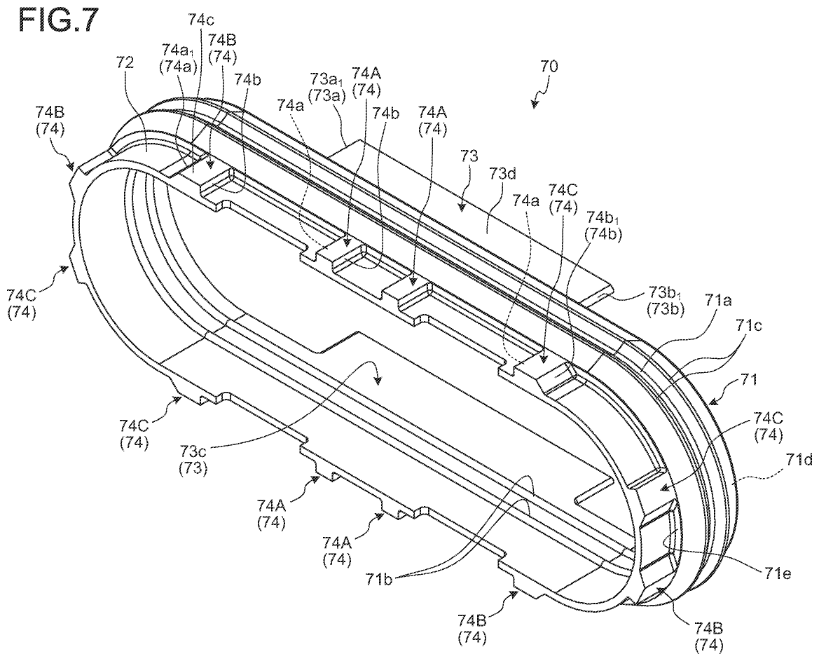

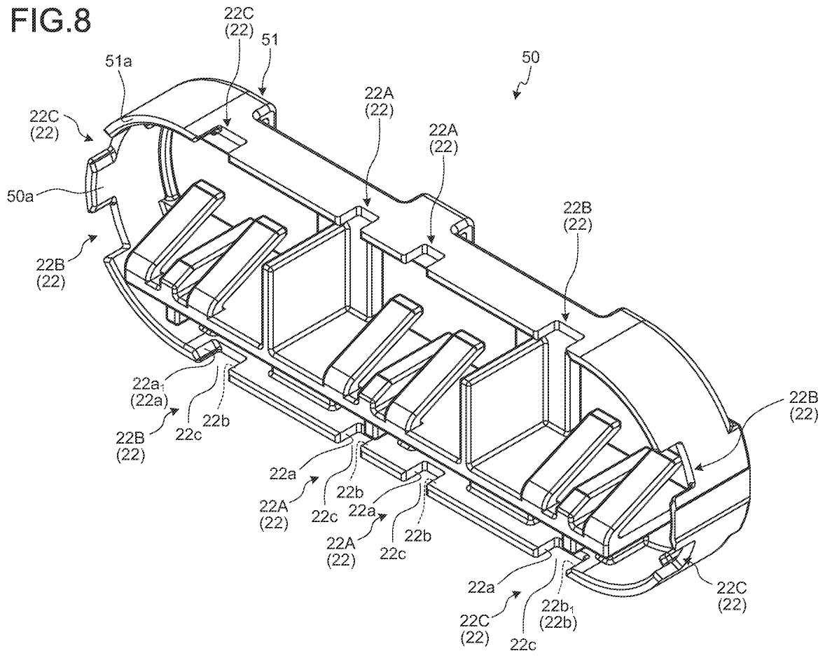

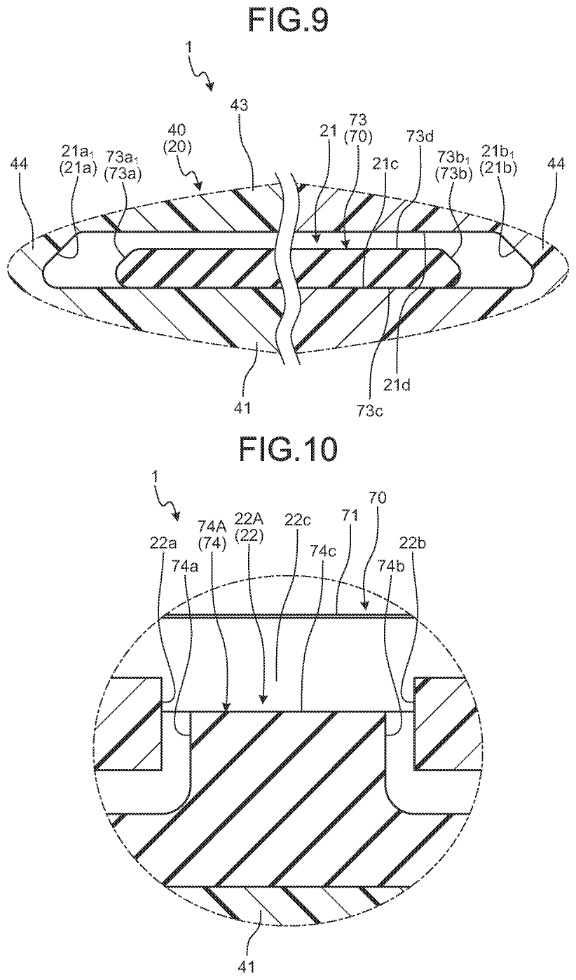

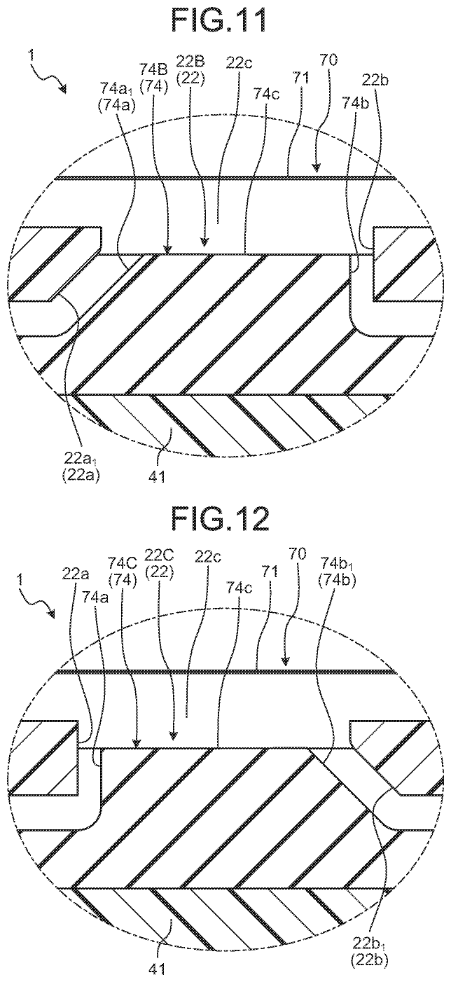

One of embodiments of the connector according to the present invention will be described based on FIGS. 1 to 12.

Reference numeral 1 in FIGS. 1 to 5 denotes a connector of the present embodiment. The connector 1 is inserted and fitted into a mating fitting portion 541 to be electrically connected to an unillustrated mating terminal fitting (FIG. 1). The mating fitting portion 541 may be formed in a cylindrical shape, or a hole shape in a wall body. The illustrated mating fitting portion 541 is formed in a hole shape having an inner circumferential wall surface 541a. The connector 1 is inserted into and removed from the hole-shaped mating fitting portion 541 along a hole axis direction of the mating fitting portion 541. The illustrated mating fitting portion 541 is formed in, for instance, a circular or elliptical shape in cross section perpendicular to the hole axis direction.

For example, the connector 1 is electrically connected to the mating terminal fitting of a mating apparatus 500 (FIG. 1) to thereby electrically connect the mating apparatus 500 and an apparatus (not illustrated) at an end of an electric wire We. The mating apparatus 500 includes a metal case 501. A through hole formed in a wall body of the case 501 is used as the mating fitting portion 541. The mating apparatus 500 also includes a terminal block or a mating connector (not illustrated) inside the case 501. The terminal block or the mating connector includes the mating terminal fitting. Thus, the connector 1 is inserted and fitted into the mating fitting portion 541 to be electrically connected to the mating terminal fitting of the terminal block or the mating connector inside the case 501.

Hereinafter, an insertion direction of the connector 3 along the hole axis direction into the mating fitting portion 541 is referred to as a connector insertion direction, and a removal direction of the connector 1 along the hole axis direction from the mating fitting portion 541 as a connector removal direction.

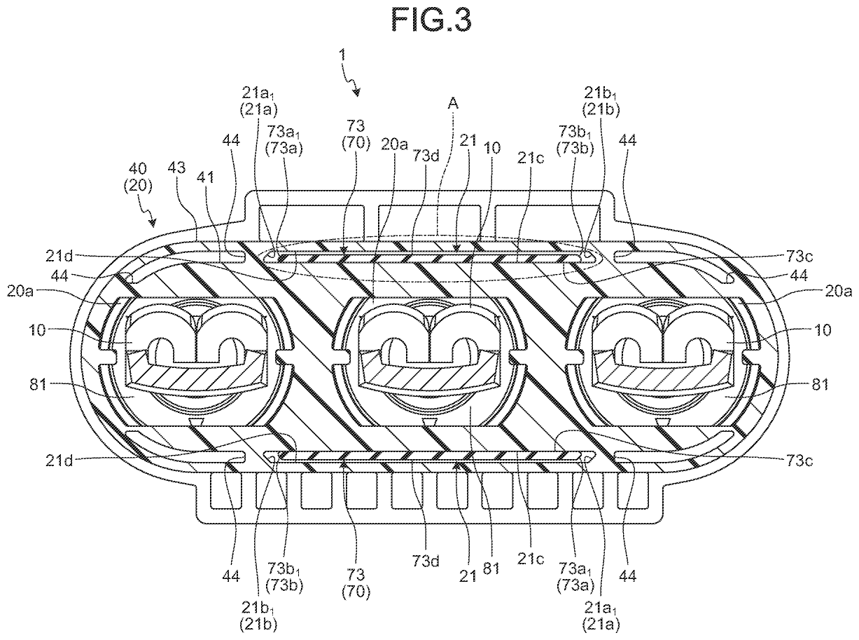

The connector 1 includes a terminal fitting 10, a housing 20, and a shield shell 30 (FIGS. 1 and 5).

The terminal fitting 10 is formed of a conductive material such as metal. For example, the terminal fitting 10 is formed into a predetermined shape by press forming such as bending and cutting of a metal plate as a base material. The terminal fitting 10 is mounted on an end of the electric wire We so as to be electrically connected to the electric wire We. The terminal fitting 10 is also electrically connected to the mating terminal fitting. Thus, the terminal fitting 10 includes a terminal connection portion 11 to be physically and electrically connected to the mating terminal fitting, and an electric wire connection portion 12 to be physically and electrically connected to the end of the electric wire We (FIG. 5).

The illustrated terminal connection portion 11 is formed in a piece body shape (FIGS. 1, 2, and 5). A through hole 11a is formed in the terminal connection portion 11. The terminal connection portion 11 is physically and electrically connected to the mating terminal fitting by, for instance, being screwed to the mating terminal fitting using the through hole 11a. Note that the connection between the terminal fitting 10 and the mating terminal fitting is not necessarily to be such a screwing structure. For example, the terminal fitting 10 and the mating terminal fitting may have shapes that can be fitted and connected with each other, one of which may be formed in a female terminal shape and the other of which may be formed in a male terminal shape.

The electric wire connection portion 12 is physically and electrically connected to the electric wire We by, for instance, being pressure-bonded or welded to a core wire at the end of the electric wire We. The illustrated electric wire connection portion 12 is pressure-bonded to the core wire by crimping two barrel pieces to the stripped core wire.

The illustrated terminal fitting 10 is formed in a straight shape in which the terminal connection portion 11 and the electric wire connection portion 12 are arranged on a straight line. Thus, the electric wire We is drawn out of the electric wire connection portion 12 in an extension direction of the terminal fitting 10 along the straight line. Note that the terminal connection portion 11 and the electric wire connection portion 12 of the terminal fitting 10 may be arranged crossing each other, e.g., arranged perpendicular to each other.

The illustrated connector 1 includes three pairs of the terminal fittings 10 and the electric wires We.

The housing 20 is formed of an insulating material such as synthetic resin. The housing 20 accommodates the terminal fittings 10 and the electric wires We therein. The housing 20 holds the terminal fittings 10 in an accommodated state, and the electric wires We are drawn outside from the inside of the housing 20. The illustrated housing 20 includes a housing body 40, a front holder 50, and a rear holder 60. The housing 20 is formed by attaching the front holder 50 and the rear holder 60 to the housing body 40 (FIG. 5).

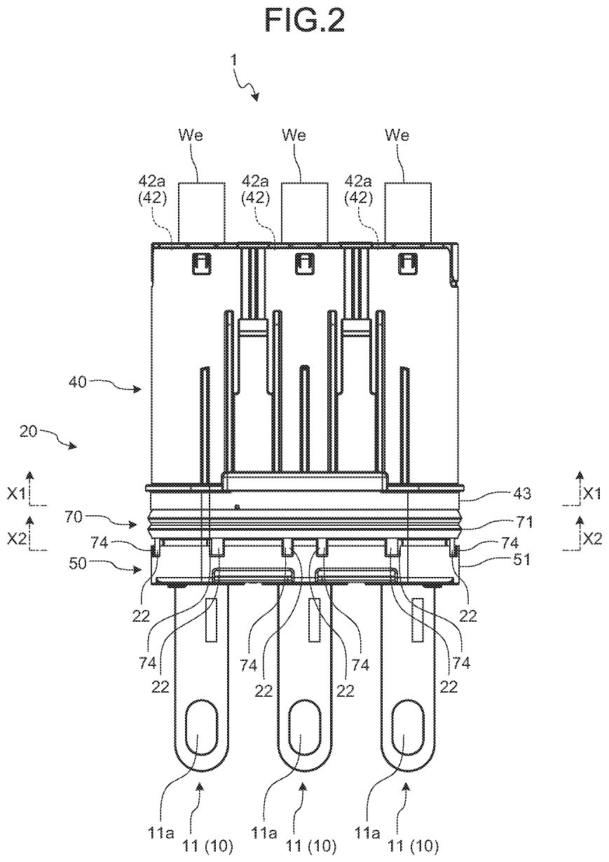

The housing 20 includes a fitting portion 41 that accommodates the terminal fittings 10 therein and is inserted and fitted into the mating fitting portion 541 along the connector insertion direction (FIGS. 3 to 6). The fitting portion 41 is inserted and fitted into the mating fitting portion 541 along the connector insertion direction, and is removed from the mating fitting portion 541 along the connector removal direction opposite thereto. For example, the fitting portion 41 is formed in a cylindrical shape whose cylinder axis direction is aligned with the connector insertion and removal directions (the connector insertion direction and the connector removal direction) with respect to the mating fitting portion 541. The fitting portion 41 is provided in the housing body 40.

The illustrated fitting portion 41 is formed in an elliptical cylindrical, shape in cross section perpendicular to the cylinder axis. The three terminal fittings 10 are arranged side by side along a longitudinal direction of the elliptical shape. Additionally, the illustrated fitting portion 41 accommodates portions of the terminal connection portions 11 closer to the electric wire connection portions 12 therein with remaining portions of the terminal connection portions 11 protruding outside therefrom. Terminal accommodation chambers 20a partitioned corresponding to the respective terminal fittings 10 are formed inside the fitting portion 41 (FIGS. 3, 4, and 6).

The housing 20 on the connector removal direction side (opposite to the connector insertion direction) from the fitting portion 41 protrudes from the mating fitting portion 541 with the fitting portion 41 inserted and fitted into the mating fitting portion 541. The housing 20 includes a cylindrical electric wire accommodation portion 42 that accommodates the electric wire connection portion 12 and the electric wire We therein, as a protruding portion from the mating fitting portion 541 on the connector removal direction side (FIGS. 1, 2, and 5). The illustrated electric wire accommodation portion 42 is formed in a circular cylindrical shape for each of the electric wires We. The inside of each electric wire accommodation portion 42 communicates with the corresponding terminal accommodation chamber 20a. The respective electric wire accommodation portions 42 are arranged in the arrangement direction of the three terminal fittings. The respective electric wire accommodation portions 42 are provided in the housing body 40.

The housing 20 further includes a cylindrical portion 43 that is provided coaxially with the cylinder axis of the fitting portion 41 with a space externally formed from an outer circumferential wall surface 41a of the fitting portion 41, at an end of the fitting portion 41 closer to the respective electric wire accommodation portions 42 (FIGS. 1 to 3, 5, and 6). The illustrated cylindrical portion 43 is formed in an elliptical cylindrical shape in cross section perpendicular to the cylinder axis. In the connector 1, the cylindrical portion 43 is also inserted and fitted into the mating fitting portion 541 together with the fitting portion 41. The cylindrical portion 43 is provided in the housing body 40.

The connector 1 includes a water stop member 70 that fills an annular gap between the fitting portion 41 and the mating fitting portion 541 (FIGS. 1 to 5, and 7). The water stop member 70 is a seal member such as a gasket for preventing entrance of liquid such as water into the gap. The water stop member 70 is formed of an elastically deformable synthetic resin material such as rubber.

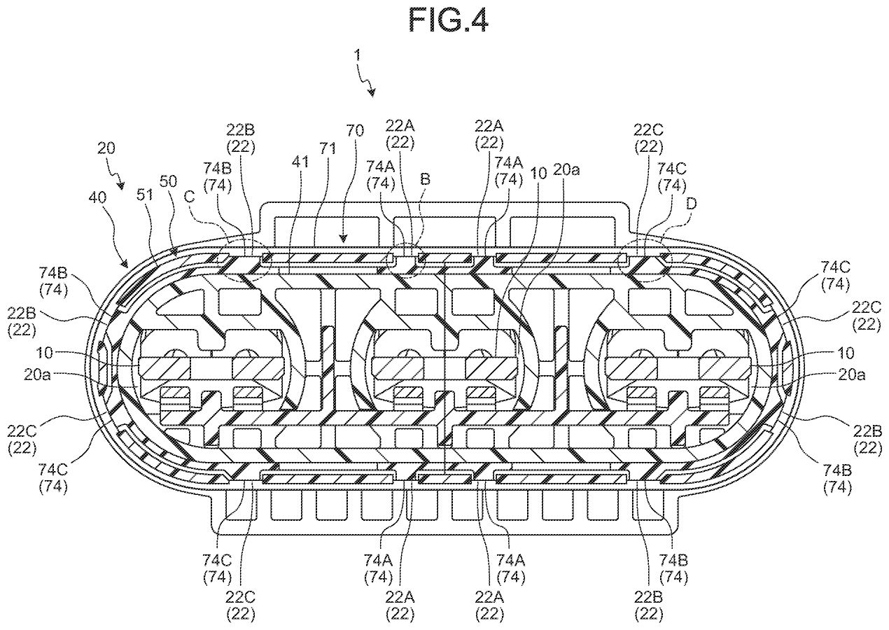

The water stop member 70 includes an annular water stop main body 71 whose inner circumferential surface is coaxially in close contact with the outer circumferential wall surface 41a (FIGS. 5 and 6) of the fitting portion 41 (FIGS. 1, 2, 4, and 7). The water stop member 70 fills the annular gap between the fitting portion 41 and the mating fitting portion 541 by the water stop main body 71 at a fitting completion position of the fitting portion 41 and the mating fitting portion 541.

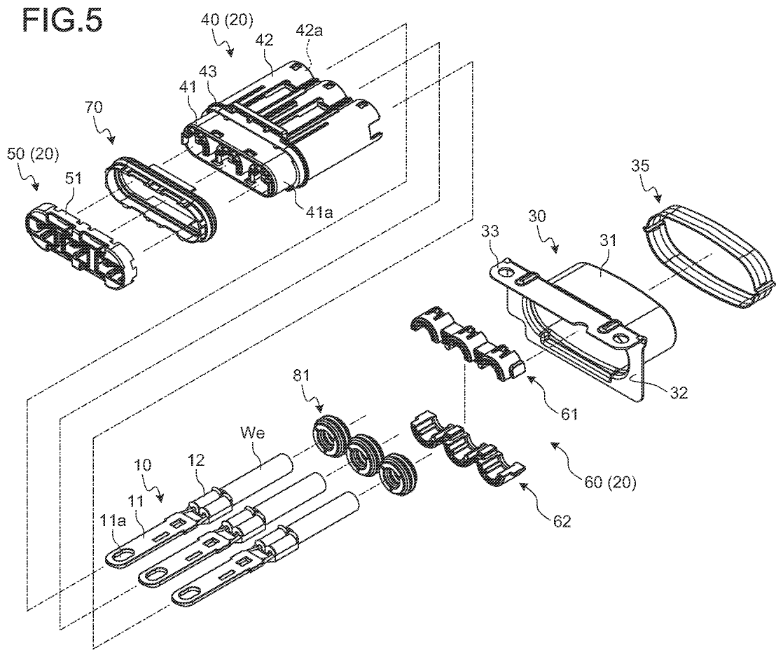

The water stop main body 71 has an annular base 71a, an annular lip (hereinafter referred to as “inner circumferential lip”) 71b coaxially protruding from an inner circumferential surface of the base 71a, and an annular lip (hereinafter referred to as “outer circumferential lip”) 71c coaxially protruding from an outer circumferential surface of the base 71a (FIG. 7). In the water stop main body 71, a plurality of the inner circumferential lips 71b and a plurality of the outer circumferential lips 71c are arranged in an axial direction of the base 71a. In the illustrated water stop main body 71, two of the inner circumferential lips 71b and two of the outer circumferential lips 71c are provided. Additionally, the illustrated base 71a is formed in an elliptical annular shape in cross section perpendicular to the axis. The inner circumferential lips 71b and the outer circumferential lips 71c illustrated herein are formed in an elliptical annular shape in cross section perpendicular to the axis of the base 71a.

The inner circumferential lips 71b on the inner circumferential side of the water stop main body 71 are elastically deformed to come into close contact with the outer circumferential wall surface 41a of the fitting portion 41 at an attachment completion position of the water stop member 70 to the fitting portion 41. The outer circumferential lips 71c on the outer circumferential side of the water stop main body 71 are also elastically deformed to come into close contact with the inner circumferential wall surface 541a of the mating fitting portion 541 at the fitting completion position of the fitting portion 41 and the mating fitting portion 541. The water stop member 70 closes the annular gap between the outer circumferential wall surface 41a of the fitting portion 41 and the inner circumferential wall surface 541a of the mating fitting portion 541 by the water stop main body 71 in such a manner, arid prevents entrance of liquid such as water: into the case 501 from between the fitting portion 41 and the mating fitting portion 541.

The fitting portion 41 is inserted into the water stop main body 71 of the water stop member 70 from a distal end on the connector insertion direction side. The water stop member 70 is moved to the attachment completion position by coaxially sliding the inner circumferential surface of the water stop main body 71 along the outer circumferential wall surface 41a of the fitting portion 41. That is, the outer circumferential wall surface 41a of the fitting portion 41 is formed so as to enable insertion of the distal end of the fitting portion 41 into the inner circumferential surface of the water stop main body 71, and coaxial sliding of the inner circumferential surface of the water stop main body 71 to the attachment completion position in the direction opposite to the connector insertion direction.

When the water stop mam body 71 is at the attachment completion position, an annular end surface 71d (FIG. 7) on the connector removal direction side of the base 71a is coaxially arranged opposite to an annular end surface 43a (FIG. 6) of the cylindrical portion 43 in the housing 20. Here, the annular end surface 43a of the cylindrical portion 43 is given an axial positioning function in moving the water stop member 70 to the attachment completion position. Thus, when the illustrated water stop main body 71 is at the attachment completion position, the annular end surface 71a of the base 71a is in abutment against the annular end surface 43a of the cylindrical portion 43.

When the water stop member 70 is slid to the attachment completion position to be completely attached to the fitting portion 41, the distal end of the fitting portion 41 on the connector insertion direction side (opposite to the sliding direction) protrudes from the water stop main body 71.

The distal end of the fitting portion 41 on the connector insertion direction side, protruding from the water stop main body 71, is coaxially inserted into the front holder 50. The front holder 50 maintains the hold state of the terminal fittings 10 in the housing 20 by being attached to the fitting portion 41 with the distal end inserted therein. The front holder 50 is formed of an insulating material such as synthetic resin.

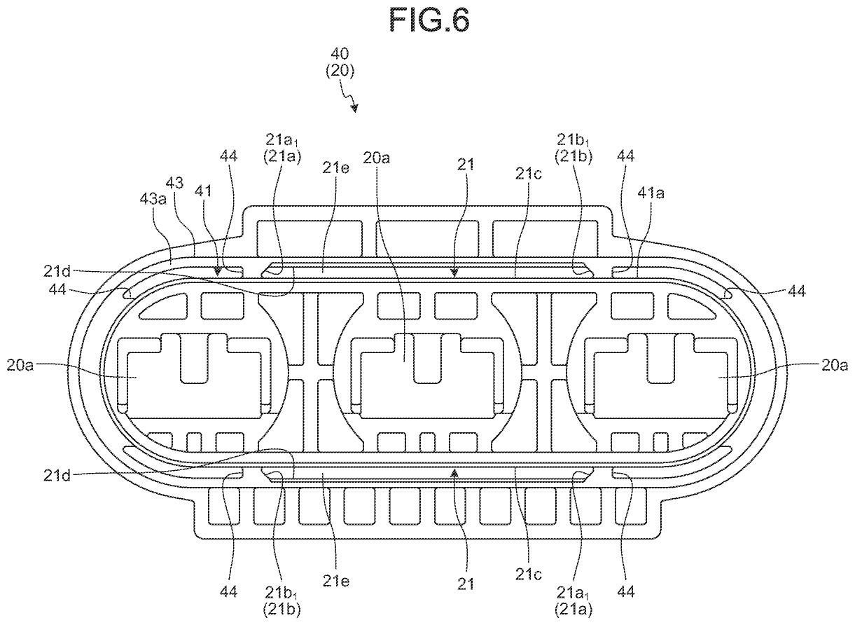

The front holder 50 is formed in a cylindrical shape opening at one end in a cylinder axis direction. The distal end of the fitting portion 41 is inserted into a cylindrical portion 51 from an opening 50a of the front holder 50 (FIGS. 1, 2, 5, and 8). The terminal connection portions 11 are protruded from an end of the front holder 50 on the opposite side from the opening 50a. The illustrated cylindrical portion 51 is formed in an elliptical cylindrical shape in cross section perpendicular to the cylinder axis. In this cylindrical portion 51, an annular end surface 51a (FIG. 8) at the opening 50a (i.e., on the connector removal direction side) is coaxially arranged opposite to an annular end surface 71e (FIG. 7) on the connector insertion direction side of the base 71a of the water stop main body 71. Here, a space is provided between the annular end surface 51a of the cylindrical portion 51 and the annular end surface 71e of the water stop main body 71 in consideration of dimensional tolerance of various components.

Here, the illustrated water stop member 70 has an annular protrusion 72 having an annular shape similar to the annular end surface 71e and coaxially protruding in the connector insertion direction from the inner circumferential surface side of the annular end surface 71e (FIGS. 4 and 7). The illustrated annular protrusion 72 is formed in an elliptical annular shape in cross section perpendicular to its axis. The annular protrusion 72 is inserted into the cylindrical portion 51. Thus, the annular end surface 51a of the cylindrical portion 51 is arranged opposite to the outer circumferential surface side of the annular end surface 71e of the water stop main body 71 with a space formed therebetween. An outer circumferential surface of the annular protrusion 72 is covered with the cylindrical portion 51 inside the cylindrical portion 51. That is, the cylindrical portion 51 is given a turn-over preventing function of preventing the annular protrusion 72 from being turned over by locking the outer circumferential surface of the annular protrusion 72 to its inner circumferential surface.

As described above, in the connector 1, the water stop main body 71 of the water stop member 70 is sandwiched between the annular end surface 43a of the cylindrical portion 43 and the annular end surface 51a of the cylindrical portion 51 of the front holder 50 in the housing 20. The connector 1 can thereby prevent axial displacement (in the connector insertion and removal directions) of the water stop member 70 relative to the fitting portion 41 and maintain the water stop member 70 at the attachment completion position to the fitting portion 41. Meanwhile, the connector 1 restricts relative rotation in a circumferential direction of the water stop member 70 (in a circumferential direction of the annular water stop main body 71) relative to the fitting portion 41 by using a rotation stop structure provided at a position between the housing 20 and the water stop member 70 as described below.

The rotation stop structure includes a portion to be accommodated 73 provided in the water stop member 70 in a protruding state in an axial direction of the water stop main body 71, and an accommodating portion 21 provided in the housing 20 to maintain the water stop member 70 at the attachment completion position to the fitting portion 41 by inserting from an opening and accommodating the portion to be accommodated 73 (FIG. 3). That is, the rotation stop structure maintains the water stop member 70 at the attachment completion position to the fitting portion 41 by accommodating the portion to be accommodated 73 in the accommodating portion 21, and enclosing the portion to be accommodated 73 by an inner circumferential surface of the accommodating portion 21 over the entire circumference. Thus, the rotation stop structure can lock circumferential movement of the portion to be accommodated 73 in the accommodating portion 21, and it can prevent circumferential displacement of the water stop member 70 relative to the fitting portion 41, and maintain the water stop member 70 at the attachment completion position to the fitting portion 41. Moreover, the rotation stop structure can lock movement of the portion to be accommodated 73 toward the inner circumferential surface and the outer circumferential surface of the water stop main body 71 in the accommodating portion 21, and thus it can prevent the portion to be accommodated 73 from being turned over toward the inner circumferential surface and the outer circumferential surface. Consequently, the connector 1 having the rotation stop structure can maintain a state in which the rotation of the water stop member 70 relative to the fitting portion 41 can be stopped.

More specifically, the accommodating portion 21 is provided in at least one of the housing body 40 or the front holder 50. That is, the rotation stop structure is provided at at least one of a position between the housing body 40 and the water stop member 70, or a position between the front holder 50 and the water stop member 70. For example, when the accommodating portion 21 is provided in the housing body 40, the portion to be accommodated 73 protrudes from the annular end surface 71d on one axial side of the water stop main body 71. For instance, the portion to be accommodated 73 in this case protrudes in the connector removal direction from the annular end surface 71d. When the accommodating portion 21 is provided in the front holder 50, the portion to be accommodated 73 protrudes from the annular end surface 71e on the other axial side of the water stop main body 71. For instance, the portion to be accommodated 73 in this case protrudes in the connector insertion direction from the annular end surface 71e.

The portion to be accommodated 73 and the accommodating portion 21 of the rotation stop structure are formed in shapes as described below so as to maintain the water stop member 70 at the attachment completion position to the fitting portion 41.

The portion to be accommodated 73 is formed in a piece body shape having respective locked ends 73a and 73b at a first end and a second end m the circumferential direction of the water stop main body 71, and a first locked wall surface 73c on the inner circumferential surface side of the water stop main body 71 and a second locked wall surface 73d on the outer circumferential surface side of the water stop main body 71, extending along the circumferential direction and the axial direction of the water stop main body 71 (FIGS. 3 and 7). The accommodating portion 21 is formed in a groove or through hole shape so as to insert from an opening and accommodate the portion to be accommodated 73. The accommodating portion 21 has a locking wall 21a at a first end in the circumferential direction capable of locking the locked end 73a at the first end, a locking wall 21b at a second end in the circumferential direction capable of locking the locked end 73b at the second end, a first locking wall surface 21c capable of locking the first locked wall surface 73c, and a second locking wall surface 21d capable of locking the second locked wall surface 73d (FIGS. 3 and 6). In the accommodating portion 21, a space surrounded by the locking wall 21a, the locking wall 21b, the first locking wall surface 21c, and the second locking wall surface 21d opens to the connector insertion direction side. Thus, the opening is used as an opening 21e into which the portion to be accommodated 73 is inserted (FIG. 6).

As described above, the rotation stop structure locks the circumferential movement of the portion to be accommodated 73 in the accommodating portion 21 by the pair of the locked end 73a and the locking wall 21a at the first circumferential end and the pair of the locked end 73b and the locking wall 21b at the second circumferential end. The rotation stop structure also locks the movement of the portion to be accommodated 73 toward the inner circumferential surface and the outer circumferential surface in the accommodating portion 21 by the first locked wall surface 73c and the first locking wall surface 21c on the inner circumferential surface side and the second locked wall surface 73d and the second locking wall surface 21d on the outer circumferential surface side. The rotation stop structure can thereby prevent the portion to be accommodated 73 from being turned over toward the inner circumferential surface and the outer circumferential surface of the water stop main body 71 while preventing the circumferential displacement of the water stop member 70 relative to the fitting portion 41. Consequently, the connector 1 can maintain the state in which the rotation of the water stop member 70 relative to the fitting portion 41 can be stopped.

Here, the locked ends 73a and 73b and the locking walls 21a and 21b paired at two positions may have tapered surfaces 73a₁, 73b₁, 21a₁, and 21b₁, which are brought into abutment against each other in each pair to lock movement of the locked ends 73a and 73b toward the second locked wall surface 73d when the tapered surfaces are in a circumferentially locked state (FIGS. 3, 6, and 7). That is, the locked end 73a at the first end may have the tapered surface (locked tapered surface) 73a₁ that is inclined closer to the first locked wall surface 73c as it approaches the locking wall 21a at the first end in the circumferential direction. The locked end 73b at the second end may have the tapered surface (locked tapered surface) 73b₁ that is inclined closer to the first locked wall surface 73c as it approaches the locking wall 21b at the second end in the circumferential direction. The locking wall 21a at the first end may have the tapered surface (locking tapered surface) 21a₁ against which the locked tapered surface 73a₁ of the locked end 73a at the first end is in abutment when the locked end 73a at the first end is in a locked state. The locking wall 21b at the second end may have the tapered surface (locking tapered surface) 21b₁ against which the locked tapered surface 73b₁ of the locked end 73b at the second end is in abutment when the locked end 73b at the second end is in a locked state.

In the portion to be accommodated 73 and the accommodating portion 21, even when a force is circumferentially applied to the locking wall 21a at the first end from the locked end 73a at the first end that is circumferentially locked to the locking wall 21a at the first end, the portion to be accommodated 73 can be prevented from being turned over toward the cuter circumferential surface because the locking tapered surface 21a₁ locks the locked tapered surface 73a₁. Additionally, in the portion to be accommodated 73 and the accommodating portion 21, even when a force is circumferentially applied to the locking wall 21b at the second end from the locked end 73b at the second end that is circumferentially locked to the locking wall 21b at the second end, the portion to be accommodated 73 can be prevented from being turned over toward the outer circumferential surface because the locking tapered surface 21b₁ locks the locked tapered surface 73b₁. Such tapered surfaces 73a₁, 73b₁, 21a₁, and 21b₁ provided in the portion to be accommodated 73 and the accommodating portion 21 as described above can improve the effect of preventing the portion to be accommodated 73 from being turned over toward the outer circumferential surface.

When the rotation stop structure is provided at both the position between the housing body 40 and the water stop member 70, and the position between the front holder 50 and the water stop member 70, the rotation stop structure may have different structures, respectively. As the rotation stop structure, the above combination of the portion to be accommodated 73 and the accommodating portion 21 is provided at one of the position between the housing body 40 and the water stop member 70, or the position between the front holder 50 and the water stop member 70, and a configuration described below is provided in the other thereof.

The rotation stop structure includes the combination of the portion to be accommodated 73 protruding from one of the two annular end surfaces 71a and 71e in the axial direction of the water stop main body 71 and the accommodating portion 21, and further includes a portion to be locked 74 protruding from the other of the two annular end surfaces 71d and 71e, and a locking portion 22 provided in the housing 20 and capable of locking the portion to be locked 74 in the circumferential direction of the water stop main body 71 while maintaining the water stop member 70 at the attachment completion position to the fitting portion 41 (FIGS. 1, 2, and 4).

The portion to be locked 74 is formed having respective locked ends 74a and 74b at a first end and a second end in the circumferential direction of the water stop main body 71, and an outer wall surface 74c on the outer circumferential surface side of the water stop main body 71 extending along the circumferential direction and the axial direction of the water stop main body 71 (FIG. 7). The locking portion 22 is formed having a locking wall 22a at a first end in the circumferential direction capable of locking the locked end 74a at the first end of the portion to be locked 74, a locking wall 22b at a second end in the circumferential direction capable of locking the locked end 74b at the second end of the portion to be locked 74, and an exposure opening 22c from which the outer wall surface 74c of the portion to be locked 74 is exposed to the outside between the locking walls 22a and 22b (FIG. 8). Moreover, the lacked ends 74a and 74b and the locking walls 22a and 22b paired at at least one position between the portion to be locked 74 and the locking portion 22 are formed having tapered surfaces 74a₁, 74b₁, 22a₁, and 22b₁, which are brought into abutment against each other to lock movement of the locked ends 74a and 74b toward the outer wall surface 74c (FIGS. 7 and 8). The tapered surfaces (locked tapered surfaces) 74a₁ and 74b₁ formed at the locked ends 74a and 74b are formed similarly to the locked tapered surfaces 73a₁ and 73b₁ of the above locked ends 73a and 73b. Additionally, the tapered surfaces (locking tapered surfaces) 22a₁ and 22b₁ formed at the locking walls 22a and 22b are formed similarly to the locking tapered surfaces 21a₁ and 21b₁ of the above locking walls 21a and 21b.

The rotation stop structure locks circumferential movement of the portion to be locked 74 between the respective locking walls 22a and 22b by the pair of the locked end 74a and the locking wall 22a at the first circumferential end and the pair of the locked end 74b and the locking wall 22b at the second circumferential end. The rotation stop structure can thereby prevent the circumferential displacement of the water stop member 70 relative to the fitting portion 41. The rotation stop structure can further prevent the portion to be locked 74 from being turned over toward the outer circumferential surface of the water stop main body 71 by the respective tapered surfaces 74a₁, 74b₁, 22a₁, and 22b₁ in the portion to be locked 74 and the locking portion 22. Consequently, the rotation stop structure can maintain the state in which the rotation of the water stop member 70 relative to the fitting portion 41 can be stopped by using the portion to be locked 74 and the locking portion 22 as well.

The illustrated rotation stop structure includes the combination of the portion to be accommodated 73 and the accommodating portion 21 at the position between the housing body 40 and the water stop member 70, and the combination of the portion to be locked 74 and the locking portion 22 at the position between the front holder 50 and the water stop member 70.

In the housing body 40 and the water stop member 70, the above portion to be accommodated 73 having a piece body shape protrudes from the annular end surface 71d on one side, i.e., the connector removal direction side, of the water stop main body 71, and is inserted from the opening 21e and accommodated in the above accommodating portion 21 having a groove or through hole shape provided in the housing body 40.

The illustrated portion to be accommodated 73 is formed in a rectangular piece body shape, and protrudes from a linear portion of the annular end surface 71d. In the portion to be accommodated 73, the locked tapered surface 73a₁ at the first end and the locked tapered surface 73b₁ at the second end are provided on one side and the other side in the circumferential direction of the water stop main body 71. Here, the respective locked tapered surfaces 73a₁ and 73b₁ are formed by forming the corresponding sides of the portion to be accommodated 73 in a wedge shape (that is, by forming the corresponding sides of the portion to be accommodated 73 in a wedge shape in cross section perpendicular to the axial direction).

The illustrated accommodating portion 21 is provided between a linear portion of the cylindrical portion 43 of the housing body 40 and a flat surface portion of the outer circumferential surface of the fitting portion 41 arranged opposite to the linear portion of the cylindrical portion 43 with a space formed therebetween (FIGS. 3 and 6). In the illustrated housing body 40, two coupling portions 44 that couple the linear portion of the cylindrical portion 43 and the flat surface portion of the outer circumferential surface of the fitting portion 41 are disposed with a space formed therebetween in the circumferential direction. The space between the two coupling portions 44 is set to the circumferential length of the accommodating portion 21. Thus, the housing body 40 uses the space surrounded by the linear portion of the cylindrical portion 43, the flat surface portion of the outer circumferential surface of the fitting portion 41, and the two coupling portions 44 as the accommodating portion 21. In the accommodating portion 21, the locking tapered surface 21a₁ at the first end and the locking tapered surface 21b₁ at the second end are provided on one of the coupling portions 44 and the other of the coupling portions 44, respectively. Here, the respective locking tapered surfaces 21a₁ and 21b₁ are formed by forming wall surfaces of the corresponding coupling portions 44 in the accommodating portion 21 in a wedge receiving shape.

The illustrated pair of the portion to be accommodated 73 and the accommodating portion 21 is provided for each combination of the linear portion of the annular end surface 71d and the linear portion of the cylindrical portion 43. That is, in the illustrated rotation stop structure, two pairs of the portions to be accommodated 73 and the accommodating portions 21 are provided in the housing body 40 and the water stop member 70.

Note that the coupling portion 44 having no relation to the accommodating portion 21, and a space between the two coupling portions 44 having no relation to the accommodating portion 21 also exist in this embodiment. In the connector 1, such a space may be also used as the above accommodating portion 21. In this case, the portion to be accommodated 73 corresponding to the accommodating portion 21 may be provided in the water stop member 70.

In the front holder 50 and the water step member 70, the portion to be locked 74 protrudes from the annular end surface 71e on the other side, i.e., the connector insertion direction side, of the water stop main body 71, and is sandwiched between the respective locking walls 22a and 22b of the locking portion 22 provided in the front holder 50.

The illustrated portion to be locked 74 is formed in such a rectangular piece body shape as to protrude in the connector insertion direction from the outer circumferential surface side of the annular end surface 7le and protrude from the outer circumferential surface of the annular protrusion 72. A plurality of the portions to be locked 74 are disposed with a space formed in the circumferential direction of the annular end surface 71e. In the water stop member 70, the tapered surfaces (locked tapered surfaces) may be provided in all the portions to be locked 74, or in only some of the portions to be locked 74.

In the illustrated water stop member 70, four of the portions to be locked 74 protrude from each of two linear portions of the annular end surface 71e, and two of the portions to be locked 74 protrude from each of two arc portions of the annular end surface 71e. The center two portions to be locked 74 in each linear portion of the annular end surface 71e are formed as first portions to be locked 74A having no locked tapered surfaces 74a₁ and 74b₁ (FIGS. 4, 7, and 10). One of the two portions to be locked 74 in each linear portion of the annular end surface 71e closer to the arc portions is formed as a second portion to be locked 74B having the locked tapered surface 74a ₁ only at the locked end 74a at the first end, and the other thereof is formed as a third portion to be locked 74C having the locked tapered surface 74b₁ only at the locked end 74b at the second end (FIGS. 4, 7, 13, and 12). Additionally, one of the two portions to be locked 74 in each arc portion is formed as the second portion to be locked 74B, and the other thereof is formed as the third portion to be locked 74C (FIGS. 4 and 7).

The illustrated locking portion 22 is formed as a cutout obtained by cutting out the cylindrical portion 51 of the front holder 50 from the opening 50a. When the front holder 50 is attached to the fitting portion 41, the portion to be locked 74 is inserted into the locking portion 22 from the opening 50a.

In the illustrated cylindrical portion 51, a first locking portion 22A having no locking tapered surfaces 22a₁ and 22b₁, as the locking portion 22 for each of the first portions to be locked 74A, a second locking portion 22B having the locking tapered surface 22a₁ only at the locking wall 22a at the first end, as the locking portion 22 for each of the second portions to be locked 74B, and a third locking portion 22C having the locking tapered surface 22b₁ only at the locking wall 22b at the second end, as the locking portion 22 for each of the third portions to be locked 74C are formed in two linear portions (FIGS. 4, 8, and 10 to 12). Additionally, in the illustrated cylindrical portion 51, the second locking portion 22B corresponding to each of the second portions to be locked 74B and the third locking portion 22C corresponding to each of the third portions to be locked 74C are formed in two arc portions (FIGS. 4 and 8).

In the connector 1 of the present embodiment, the electric wires We with the terminal fittings 10 are inserted into the housing body 40 from openings 42a of the electric wire accommodation portions 42 (FIG. 5). Thus, the electric wires We are drawn outside from the openings 42a. Here, an annular gap is formed between each electric wire accommodation portion 42 and the corresponding electric wire We. Thus, in the connector 1, the electric wire We is previously passed through an annular water stop member (so-called rubber stopper) 81 (FIGS. 3 and 5), and the water stop member 81 is inserted into the electric wire accommodation portion 42 together with the electric wire We. The annular gap between each electric wire accommodation portion 42 and the corresponding electric wire We is thereby closed.

The rear holder 60 is attached between the openings 42a of the electric wire accommodation portions 42 and the water stop members 81 to hold the electric wires We while preventing bending of the electric wires We. The illustrated rear holder 60 has a two-split structure having a first holder member 61 and a second holder member 62. The first holder member 61 and the second holder member 62 sandwich and hold the respective electric wires We (FIG. 5). The respective electric wires We are drawn outside from the corresponding openings 42a via the rear holder 60. Although not described in detail, claws provided in the first holder member 61 and the second holder member 62 are inserted into through holes of the respective electric wire accommodation portions 42. The rear holder 60 is thereby held in the respective electric wire accommodation portions 42. The first holder member 61 and the second holder member 62 are formed of, for example, an insulating material such as synthetic resin.

The shield shell 30 covers the respective electric wire accommodation portions 42 from the outside, thereby preventing entrance of noise into the electric wires We from the outside. Thus, the shield shell 30 is formed of a metal material (e.g., aluminum or aluminum alloy).

The shield shell 30 has a cylindrical accommodation body 31 that covers the respective electric wire accommodation portions 42 from the outside (FIGS. 1 and 3). The illustrated accommodation body 31 is formed in an elliptical cylindrical shape in cross section perpendicular to its cylinder axis. The three electric wire accommodation portions 42 are arranged parallelly along a longitudinal direction of the elliptical shape.

The shield shell 30 also has a flange 32 provided to an end of the accommodation body 31 on the connector insertion direction side (FIGS. 1 and 3). The flange 32 is formed in an annular and flat plate shape. A flat surface of the flange 32 on the connector insertion direction side is arranged opposite to an outer wall surface 501a of the case 501 at the fitting completion position (FIG. 1).

The shield shell 30 also has a fixing portion 33 to be fixed to the case 501 (FIGS. 1 and 5). For example, the illustrated case 501 has a perpendicular wall surface 501b perpendicularly continuing from the outer wall surface 501a (FIG. 1). In the shield shell 30, the fixing portion 33 is formed in a flat plate shape perpendicularly continuing from the flange 32. The fixing portion 33 is fixed to the case 501 by being screwed to the perpendicular wall surface 501b with which a flat surface of the fixing portion 33 is in close contact. Thus, the perpendicular wall surface 501b has a fixed portion 501c as a female threaded portion (FIG. 1). The fixed portion 501c is formed as the female threaded portion whose thread axis is aligned with a direction perpendicular to the perpendicular wall surface 501b. A through hole 33a corresponding to the fixed portion 501c is also formed in the fixing portion 33 (FIG. 1). The fixing portion 33 is fixed to the case 501 by screwing a male threaded member (not illustrated) into the fixed portion 501c via the through hole 33a.

The connector 1 includes a braid (not illustrated) that covers an outer circumferential surface of the accommodation body 31 and the electric wires We drawn outside from the respective openings 42a. The braid is a member braided in a cylindrical and mesh form by a metal material, and prevents entrance of noise into the electric wires We drawn outside from the respective openings 42a. The braid is brought into pressure contact with the outer circumferential surface of the accommodation body 31 by using a cylindrical connection member 35 (FIGS. 1 and 5).

As described above, the connector 1 of the present embodiment is provided with the rotation stop structure including the portion to be accommodated 73 and the accommodating portion 21 at the position between the housing 20 and the water step member 70. The connector 1 can thereby maintain the state in which the rotation of the water stop member 70 relative to the fitting portion 41 can be stopped. The connector 1 of the present embodiment is also provided with the rotation stop structure including the combination of the portion to be locked 74 and the locking portion 22 in addition to the combination of the portion to be accommodated 73 and the accommodating portion 21 at the position between the housing 20 and the water stop member 70. The connector 1 can thereby maintain the state in which the rotation of the water stop member 70 relative to the fitting portion 41 can be stopped.

The connector according to the embodiment is provided with the rotation stop structure that maintains the water stop member at the attachment completion position to the fitting portion by accommodating the portion to be accommodated in the accommodating portion, and enclosing the portion to be accommodated by the inner circumferential surface of the accommodating portion over the entire circumference. The rotation stop structure can lock the circumferential movement of the portion to be accommodated in the accommodating portion, thereby preventing the circumferential displacement of the water stop member relative to the fitting portion, and maintaining the water stop member at the attachment completion position to the fitting portion. Moreover, the rotation stop structure can lock the movement of the portion to be accommodated toward the inner circumferential surface and the outer circumferential surface of the water stop main body in the accommodating portion, thereby preventing the portion to be accommodated from being turned over toward the inner circumferential surface and the outer circumferential surface. Consequently, the connector having the rotation stop structure can maintain the state in which the rotation of the water stop member relative to the fitting portion can be stopped.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a terminal fitting;
a housing accommodating the terminal fitting therein and including a fitting portion to be inserted and fitted into a mating fitting portion along a connector insertion direction;
a water stop member including an annular water stop main body, an inner circumferential surface of which is coaxially in close contact with an outer circumferential wall surface of the fitting portion, the water stop member being elastically deformable so as to fill an annular gap between the fitting portion and the mating fitting portion by the water stop main body at a fitting completion position of the fitting portion and the mating fitting portion; and
a rotation stop structure provided at. a position between the housing and the water stop member to restrict relative rotation in a circumferential direction of the water stop member relative to the fitting portion, wherein
the rotation stop structure includes a portion to be accommodated protruding from an annular end surface in an axial direction of the water stop main body, and an accommodating portion provided in the housing to maintain the water stop member at an attachment completion position to the fitting portion by inserting from an opening and accommodating the portion to be accommodated.

2. The connector according to claim 1, wherein
the portion to be accommodated is formed in a piece body shape having a locked end at a first end and a locked end at a second end in the circumferential direction, and first locked wall surface on the inner circumferential surface side and a second locked wall surface on an outer circumferential surface side of the water stop main body, the first locked wall surface and the second locked wall surface extending along the circumferential direction and the axial direction, and
the accommodating portion has a locking wall at a first end in the circumferential direction capable of locking the locked end at the first end, a locking wall at a second end in the circumferential direction capable of locking the locked end at the second end, a first locking wall surface capable of locking the first locked wall surface, and a second locking wall surface capable of locking the second locked wall surface.

3. The connector according to claim 2, wherein
the locked ends and the locking walls paired at two positions have tapered surfaces to be brought into abutment against each other in each pair to lock movement of the locked ends toward the second locked wall surface when the tapered surfaces are in a circumferentially locked state.

4. The connector according to claim 1, wherein
the housing includes a housing body provided with the fitting portion, and a front holder into which a distal end of the fitting portion on the connector insertion direction side, protruding from the water stop main body, is coaxially inserted,
the accommodating portion is provided in at least one of the housing body and the front holder,
when the accommodating portion is provided in the housing body, the portion to be accommodated protrudes from one or the annular end surfaces of the water stop main body in a direction opposite to the connector insertion direction, and
when the accommodating portion is provided in the front holder, the portion to be accommodated protrudes from the other of the annular end surfaces of the water stop main body in the connector insertion direction.

5. The connector according to claim 2, wherein
the housing includes a housing body provided with the fitting portion, and a front holder into which a distal end of the fitting portion on the connector insertion direction side, protruding from the water stop main body, is coaxially inserted,
the accommodating portion is provided in at least one of the housing body and the front holder,
when the accommodating portion is provided in the housing body, the portion to be accommodated protrudes from one of the annular end surfaces of the water stop main body in a direction opposite to the connector insertion direction, and
when the accommodating portion is provided in the front holder, the portion to be accommodated protrudes from the other of the annular end surfaces of the water stop main body in the connector insertion direction.

6. The connector according to claim 3, wherein
the housing includes a housing body provided with the fitting portion, and a front holder into which a distal end of the fitting portion on the connector insertion direction side, protruding from the water stop main body, is coaxially inserted,
the accommodating portion is provided in at least one of the housing body and the front holder,
when the accommodating portion is provided in the housing body, the portion to be accommodated protrudes from one of the annular end surfaces of the water stop main body in a direction opposite to the connector insertion direction, and
when the accommodating portion is provided in the front holder, the portion to be accommodated protrudes from the other of the annular end surfaces of the water stop main body in the connector insertion direction.

7. The connector according to claim 1, wherein
the rotation stop structure includes a combination of the portion to be accommodated protruding from one of the annular end surfaces of the water stop main body and the accommodating portion, and further includes a portion to be locked protruding from the other of the annular end surfaces of the water stop main body, and a locking portion provided in the housing and capable of locking the portion to be locked in the circumferential direction while maintaining the water stop member at the attachment completion position,
the portion to be locked has a locked end at a first end and a locked end at a second end in the circumferential direction, and an outer wall surface on the cuter circumferential surface aide of the water stop main body extending along the circumferential direction and the axial direction,
the locking portion has a locking wall at a first end in the circumferential direction capable of locking the locked end at the first end of the portion to be locked, a locking wall at a second end in the circumferential direction capable of locking the locked end at the second end of the portion to be locked, and an exposure opening from which the outer wall surface of the portion to be locked is exposed to an outside between the locking walls,
the locked ends and the locking walls paired at at least one position in the portion to be locked and the locking portion have tapered surfaces to be brought into abutment against each other to lock movement of the locked ends toward the outer wall surface,
the housing includes a housing body provided with the fitting portion, and a front holder into which a distal end of the fitting portion on the connector insertion direction side, protruding from the water stop main body, is coaxially inserted,
the combination of the portion to be accommodated and the accommodating portion is provided at one of a position between the housing body and the water stop member, and a position between the front holder and the water stop member, and
a combination of the portion to be locked and the locking portion is provided at the other of the position between the housing body and the water stop member, and the position between the front holder and the water stop member.

8. The connector according to claim 2, wherein
the rotation stop structure includes a combination of the portion to be accommodated protruding from one of the annular end surfaces of the water stop main body and the accommodating portion, and further includes a portion to be locked protruding from the other of the annular end surfaces of the water stop main body, and a locking portion provided in the housing and capable of locking the portion to be locked in the circumferential direction while maintaining the water stop r,ember at the attachment completion position,
the portion to be locked has a locked end at a first end and a locked end at a second end in the circumferential direction, and an outer wall surface on the outer circumferential surface side of the water stop main body extending along the circumferential direction and the axial direction,
the locking portion has a locking wall at a first end in the circumferential direction capable of locking the locked end at the first end of the portion to be locked, a locking wall at a second end in the circumferential direction capable of locking the locked end at the second end of the portion to be locked, and an exposure opening from which the outer wall surface of the portion to be locked is exposed to an outside between the locking walls,
the locked ends and the locking walls paired at at least one position in the portion to be lacked and the locking portion have tapered surfaces to be brought into abutment against each other to lock movement of the locked ends toward the outer wall surface,
the housing includes a housing body provided with the fitting portion, and a front holder into which a distal end of the fitting portion on the connector insertion direction side, protruding from the water stop main body, is coaxially inserted,
the combination of the portion to be accommodated and the accommodating portion is provided at one of a position between the housing body and the water stop member, and a position between the front holder and the water stop member and
a combination of the portion to be locked and the locking portion is provided at the other of the position between the housing body and the water stop member, and the position between the front holder and the water stop member

9. The connector according to claim 3, wherein the rotation stop structure includes a combination of the portion to be accommodated protruding from one of the annular end surfaces of the water stop main body and the accommodating portion, and further includes a portion to be locked protruding from the other of the annular end surfaces of the water stop main body, and a locking portion provided in the housing and capable of locking the portion to be locked in the circumferential direction while maintaining the water stop member at the attachment completion position,
the portion to be locked has a locked end at a first end and a locked end at a second end in the circumferential direction, and an outer wall surface on the outer circumferential surface 3ide of the water stop main body extending along the circumferential direction and the axial direction,
the locking portion has a locking wall at a first end in the circumferential direction capable of locking the locked end at the first end of the portion to be locked, a locking wall at a second end in the circumferential direction capable of locking the locked end at the second end of the portion to be locked, and an exposure opening from which the outer wall surface of the portion to be locked is exposed to an outside between the locking walls,
the locked ends and the locking walls paired at at least one position in the portion to be locked and the locking portion have tapered surfaces to be brought into abutment against each other to lock movement of the locked ends toward the outer wall surface,
the housing includes a housing body provided with the fitting portion, and a front holder into which a distal end of the fitting portion on the connector insertion direction side, protruding from the water stop main body, is coaxially inserted,
the combination of the portion to be accommodated and the accommodating portion is provided at one of a position between the housing body and the water stop member, and a position between the front holder and the water stop member and
a combination of the portion to be locked and the locking portion is provided at the other of the position between the housing body and the water stop member, and the position between the front holder and the water stop member.
